(19) United States
(12) Patent Application Publication
(10) Pub. No.: US 2006/0083384 A1
(43) Pub. Date: Apr. 20, 2006

(54) Amplitude and phase compensator for BTSC encoder

(76) Inventors: Luciano Zoso, Chandler, AZ (US); Allan P. Chin, Phoenix, AZ (US); David P. Lester, Phoenix, AZ (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/966,877

(22) Filed: Oct. 15, 2004

(51) Int. Cl. H04R 5/00; H04H 5/00

(52) U.S. Cl. 381/23; 381/2; 381/16

(57) ABSTRACT

A BTSC encoder includes a sum channel (L+R), a difference channel (L−R), and one or more of a phase compensator and an amplitude compensator. The sum channel (L+R) has a L audio input for receiving a digital L audio signal, a right (R) audio input for receiving a digital R audio signal, and an output for providing a digital L+R signal. The difference channel (L−R) has a L audio input for receiving the digital L audio signal, a right (R) audio input for receiving the digital R audio signal, and an output for providing a digital L−R signal. The phase compensator is coupled to the sum channel and/or the difference channel, and is for compensating for a phase difference between the digital L+R signal and the digital L−R signal. The amplitude compensator is coupled to the sum channel and/or the difference channel, for compensating for an amplitude difference between the digital L+R signal and the digital L−R signal.

### BACKGROUND

The present disclosure relates to stereophonic audio encoders, and more particularly, to single-chip BTSC encoders.

Related Art

At present DVD players, stereo VCRs, set-top boxes, gaming stations and similar audio/video applications output composite video and stereo audio through three separate connectors (video, left audio and right audio). In view of the complexity in using three separate cables, a popular method of connecting TV sets to other audio/video applications is through a single RF cable, wherein the single RF cable conveys both composite video and mono audio. However, in such a typical home entertainment configuration, the stereo audio provided by cable television or satellite equipment is not passed on to the audio/video equipment, such as VCRs and television sets, because stereo audio is only available through the discrete left and right outputs of the set-top box, but not through the RF output of the same.

In the American NTSC system, the stereo audio signals are encoded with the Broadcast Television System Committee (BTSC) encoding. This analog standard for Multichannel Television Sound (MTS) was adopted in 1984 by the FCC for television broadcast of stereo audio. An analog BTSC encoder is used to generate a composite audio signal consisting of a Left+Right (L+R) channel (main channel), a pilot tone, and an encoded and modulated Left−Right (L−R) channel (stereo channel). The analog BTSC encoder includes filters that are analog and that have transfer functions described by Laplace transforms. The main channel occupies the baseband spectrum from 50 Hz to 14 kHz and, when modulated, has a 25 kHz peak deviation. The pilot tone is a single tone at approximately 15.734 kHz (exactly the horizontal line rate of the NTSC system) and, when modulated, has a 5 kHz deviation. The stereo channel is a double sideband suppressed carrier signal centered at approximately 31.468 kHz (exactly twice the horizontal line rate of the NTSC system) with a bandwidth of 28 kHz. When modulated, the peak deviation of the stereo channel is 50 kHz.

Traditional analog BTSC encoding systems are typically expensive. The analog approach is complex, requires substantial space, and is not easily integrated with other system functions. Furthermore, the manufacturing process for the analog circuitry necessitates adjustments and is subject to environmental and aging effects that can noticeably degrade system performance. Due to cost and complexity, analog BTSC encoders have been used mainly in broadcast equipment, and not in equipment for general consumer applications.

Digital solutions are more suitable for consumer applications. Existing digital BTSC encoders are typically implemented in digital signal processor (DSP) chips or field programmable gate arrays (FPGAs). However, such chips are costly relative to application specific integrated circuits (ASICs) when mass produced. Furthermore, expensive external analog to digital converters (ADCs), digital to analog converters (DACs) and sync separators may be necessary.

In traditional digital BTSC encoder implementations, the accuracy of the amplitude and/or phase versus frequency response of the L+R and L−R channels can deviate from the nominal values specified by the BTSC standard. The effect of these errors is a loss of stereo separation, i.e., an inability to accurately reproduce the original left and right channels at the decoder. The reason for the errors is usually due to the limitations of translating complex analog filter responses accurately into the digital domain. Stereophonic separation can be defined as the ratio of the electrical signal caused in the right (or left) stereophonic channel to the electrical signal caused in the left (or right) stereophonic channel by the transmission of only a left (or right) signal. For instance, the separation of a BTSC encoder system can be determined by injecting a signal on the left channel and computing at the decoder output, the ratio of the power of the right channel to the power of the left channel.

In a digital BTSC encoder implementation, the filters must be converted into the digital domain. Conversion approximations and compromises made to reduce the hardware complexity of the digital filters result in amplitude and phase errors in the left+right and left−right channels, compared to the original analog standard. These errors significantly reduce the channel separation.

Accordingly, there is a need for an improved method and apparatus for overcoming the problems in the art as discussed above.

### SUMMARY

According to an embodiment of the present disclosure, a BTSC encoder includes a sum channel (L+R), a difference channel (L−R), and one or more of a phase compensator and an amplitude compensator. The sum channel (L+R) has a L audio input for receiving a digital L audio signal, a right (R) audio input for receiving a digital R audio signal, and an output for providing a digital L+R signal. The difference channel (L−R) has a L audio input for receiving the digital L audio signal, a right (R) audio input for receiving the digital R audio signal, and an output for providing a digital L−R signal. The phase compensator is coupled to the sum channel and/or the difference channel, and is for compensating for a phase difference between the digital L+R signal and the digital L−R signal. The amplitude compensator is coupled to the sum channel and/or the difference channel, for compensating for an amplitude difference between the digital L+R signal and the digital L−R signal.

### BRIEF DESCRIPTION OF THE DRAWINGS

The present invention is illustrated by way of example and not limited by the accompanying figures, in which like references indicate similar elements, and in which:

FIG. 1 is a schematic block diagram view of a composite video and stereo audio system having a BTSC encoder with an RF modulator according to one embodiment of the present disclosure;

FIG. 2 is a schematic block diagram view of a BTSC encoder of FIG. 1 in further detail according to one embodiment of the present disclosure;

FIG. 3 is a schematic block diagram view of a BTSC encoder of FIG. 1 in further detail according to another embodiment of the present disclosure;

FIG. 4 is a schematic block diagram view of a BTSC encoder of FIG. 1 in further detail according to another embodiment of the present disclosure;

FIG. 5 is a schematic block diagram view of a BTSC encoder of FIG. 1 in further detail according to yet another embodiment of the present disclosure;

FIG. 6 is a schematic block diagram view of a portion of the audio processor of the BTSC encoder of FIG. 1 in further detail according to another embodiment of the present disclosure;

FIG. 7 is a graphical representation view of the stereo channel separation of (i) a BTSC encoder without amplitude and phase compensators and (ii) a BTSC encoder with amplitude and phase compensators according to one embodiment of the present disclosure;

FIG. 8 is a graphical representation view of an amplitude response of the amplitude compensator of the BTSC encoder according to one embodiment of the present disclosure;

FIG. 9 is a schematic block diagram view of a portion of the audio processor of the BTSC encoder of FIG. 1 in further detail according to yet another embodiment of the present disclosure; and

FIG. 10 is a schematic block diagram view of a portion of the audio processor of the BTSC encoder of FIG. 1 in further detail according to yet still another embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

The present embodiments relate to stereophonic audio encoders used for audio/video consumer electronics and more specifically to a fully integrated digital BTSC compatible encoder. In one embodiment, a single-chip BTSC encoder incorporates an Audio Processor, a dual-channel Sigma-Delta ADC, a dual-channel Sigma-Delta DAC, and a Sync Separator. The BTSC signal processing algorithms can include, for example, commercially available signal processing algorithms available from Cable Electronics, Inc.

A BTSC encoder, in conjunction with an RF modulator, provides composite video and high-quality stereo sound through a single RF coaxial cable. As a result, it will greatly simplify the typical home entertainment wiring scheme. Moreover, this allows consumer electronics manufacturers to lower overall system costs.

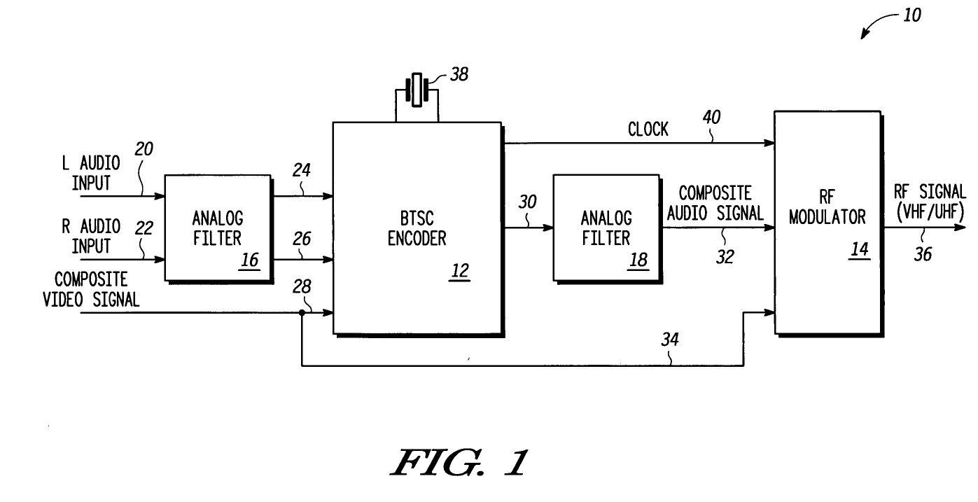

FIG. 1 is a schematic block diagram view of a composite video and stereo audio system 10 having a BTSC encoder 12 with an RF modulator 14 according to one embodiment of the present disclosure. System 10 further includes analog filters 16 and 18. Furthermore, system 10 may be implemented as an integrated circuit implementation of the BTSC encoder, RF modulator, and analog filters.

Analog filter 16 includes a left audio input 20 for receiving a left audio input signal and a right audio input 22 for receiving a right audio signal. Responsive to the left audio and right audio input signals, analog filter 16 outputs filtered left and right audio input signals on filter output signal lines 24 and 26, respectively. Analog filter 16 is an anti alias filter and is used to filter frequencies that may cause spurious outputs from ADCs contained within BTSC encoder 12.

BTSC encoder 12 includes a left audio input 24, a right audio input 26, and a composite video input. The left audio input 24 is adapted for receiving a left audio input signal, for example, a filtered L audio input signal. The right audio input 26 is adapted for receiving a right audio signal, for example, a filtered R audio input signal. Furthermore, the composite video input 28 is adapted for receiving a composite video signal. Responsive to the left audio, right audio, and composite input signals, the BTSC encoder 12 digitally encodes the left and right audio input signals into a composite audio signal and outputs the composite audio signal on a composite analog audio output 30. In one embodiment, the BTSC encode 12 includes a single-chip BTSC encoder.

RF modulator 14 includes a composite audio input 32 coupled to the composite audio output 30 of the BTSC encoder 12, for example, via analog filter 18, for receiving the composite audio output signal. RF modulator 14 further includes a composite video input 34 for receiving the composite video signal. Responsive to the input signals, RF modulator 14 frequency modulates the composite audio signal and combines the modulated audio signal with a composite video input signal to form a composite RF modulated output signal and outputs the RF modulated output signal on an RF modulated output 36. In one embodiment, analog filter 18 is a smoothing filter and filters any spurious signals outside the frequency band of the composite audio signal.

In addition, as illustrated in FIG. 1, a crystal 38 couples to BTSC encoder 12. Crystal 38 is adapted for use in connection with providing clocking signals internal to the BTSC encoder 12, as well as, providing a clocking signal external to the BTSC encoder. For example, an external clock signal is provided on signal line 40 coupled to RF modulator 14, for supplying RF modulator 14 with appropriate timing from a clock within BTSC encoder 12.

Accordingly, the BTSC encoder chip accepts left and right analog audio signals, as well as a baseband composite video signal. Responsive to the input signals, the BTSC encoder generates L+R and modulated L−R signals in accordance with the standards for the BTSC system. In the past, the two channels were required to be added together in the analog domain to generate a composite audio signal. However, with the embodiments of the present disclosure, adding of the two channels in the analog domain is no longer necessary, because the BTSC encoder chip can produce the composite audio directly. Such a BTSC encoder chip is believed the industry's first single-chip BTSC encoder.

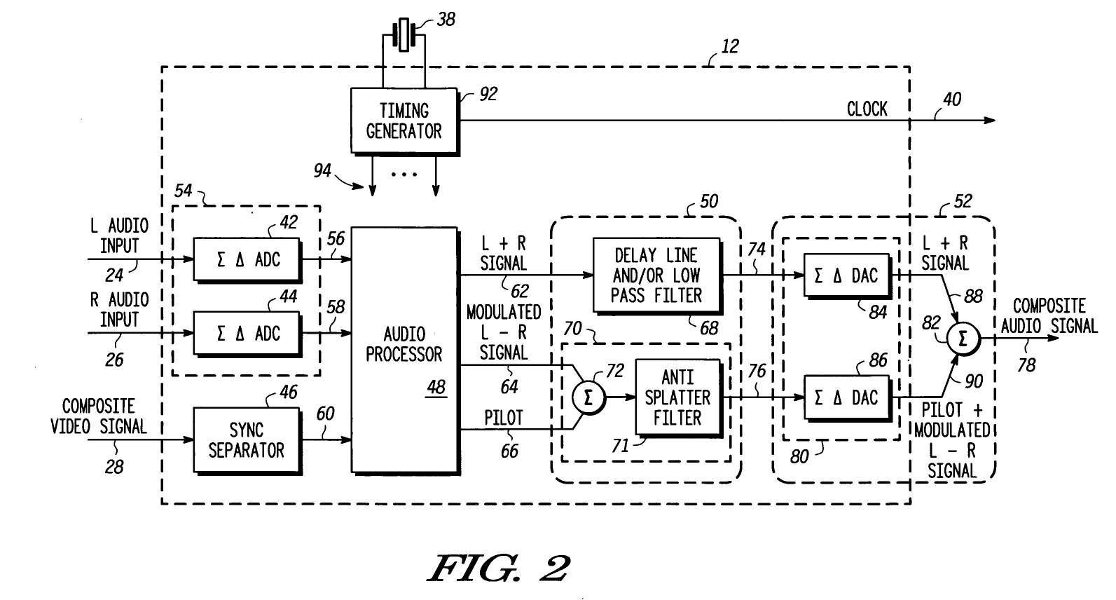

FIG. 2 is a schematic block diagram view of a BTSC encoder of FIG. 1 in further detail according to one embodiment of the present disclosure. BTSC encoder 12 includes analog-to-digital converters (ADCs) (42,44), a sync separator 46, an audio processor 48, filtering means 50, and composite audio signal generating means 52.

In one embodiment, analog-to-digital converters (42,44) include a dual-channel sigma-delta analog-to-digital converter (ADC) 54. Dual-channel sigma-delta ADC 54 has a left (L) audio input 24 adapted for receiving a left (L) audio signal and a right (R) audio input 26 adapted for receiving a right (R) audio signal. Responsive to L audio and R audio input signals, the dual-channel sigma-delta ADC 54 converts the input signals into left and right digital audio output signals, respectively, and outputs the left and right digital audio output signals onto left and right digital audio outputs designated by reference numerals 56 and 58, respectively.

Sync separator 46 includes a composite video input 28 adapted for receiving a composite video signal. Responsive to the composite video input signal, sync separator 46 separates a horizontal synchronization signal from the composite video input signal and outputs the synchronization signal on a synchronization output 60.

Audio processor 48 includes left and right digital audio inputs coupled to the left and right digital audio outputs (56,58) of the dual-channel sigma-delta ADC 54. Audio processor 48 also includes a synchronization signal input coupled to the synchronization output 60 of the sync separator 46. Responsive to left and right digital audio input signals and a synchronization signal, the audio processor 48 processes the input and synchronization signals into an L+R signal, a modulated L−R signal, and a pilot tone signal. Furthermore, the audio processor outputs the L+R, modulated L−R, and pilot tone signals on an L+R output 62, a modulated L−R output 64, and a pilot tone output 66, respectively.

Filtering means 50 couples to the L+R output 62, the modulated L−R output 64, and the pilot tone output 66 of the audio processor 48. In the embodiment of FIG. 2, the filtering means 50 includes a first filter 68 for providing a filtered or delayed L+R signal, and a second filter 70 for providing a filtered and combined pilot and modulated L−R signal. The second filter 70 includes an anti-splatter filter 71 and a digital summer 72, wherein the modulated L−R and pilot are combined via the digital summer 72. Furthermore, the filtering means 50 outputs the filtered L+R signal on a first output 74, and outputs the filtered and combined pilot and modulated L−R signal on a second output 76.

Composite audio signal generating means 52 couples to the first output 74 and the second output 76. Responsive to the filtered L+R signal and the filtered and combined pilot and modulated L−R signal, the composite audio signal generating means generates a composite audio signal. The composite signal generating means 52 outputs the composite audio signal on a composite analog audio signal output 78.

As discussed above, the second filter 70 of filtering means 50 provides a filtered and combined pilot and modulated L−R signal. In one embodiment, the second filter 70 includes a digital summer 72 for combining the pilot and modulated L−R signals. The digital summer 72 couples to an input of anti-splatter filter 71, the anti-splatter filter having an output for providing the filtered and combined pilot and modulated L−R signal output corresponding to second output 76. Anti-splatter filter 71 reduces an amount of an out-of-band noise added to the L+R signal as a function of a combination of the pilot tone and an unfiltered modulated L−R signal. In one embodiment, the anti-splatter filter 71 includes one of a bandpass filter and a highpass filter. In another embodiment, the first filter includes 68 includes one of a delay line and a low pass filter.

Referring still to FIG. 2, composite audio signal generating means 52 includes a dual-channel sigma-delta digital-to-analog converter (DAC) 80 and an analog summing device 82. In one embodiment, dual-channel sigma-delta DAC 80 includes a first input coupled to the L+R output 62 of audio processor 48, for example, via filtering means 50. Dual-channel sigma-delta DAC 80 further includes a second input coupled to the modulated L−R signal output 64 and pilot tone output 66 of audio processor 48, for example, via filtering means 50. Responsive to the L+R digital audio signal and the combined modulated L−R digital audio and pilot tone signal, the dual-channel sigma-delta DAC 80 converts the input signals into L+R and combined pilot and modulated L−R analog audio output signals, respectively. Further more, the dual-channel sigma-delta DAC outputs the L+R and combined pilot and modulated L−R analog audio output signals on outputs 88 and 90, respectively.

The analog summing device 82, in one embodiment, includes a L+R analog audio input and a combined pilot and modulated L−R analog audio input coupled to the L+R and combined pilot and modulated L−R analog audio outputs 88 and 90, respectively, of the dual-channel sigma-delta DAC 80. Analog summing device 82 is adapted for summing the L+R and combined modulated L−R analog audio output signals into a composite analog audio signal. The analog summing device 82 outputs the composite analog audio signal on an analog summing device output 78.

Further with respect to FIG. 2, BTSC encoder 12 includes a timing generator 92. Crystal 38 couples to timing generator 92, wherein timing generator 92 provides one or more clock signal outputs, as discussed herein, or as may be required for a particular BTSC encoder application. For example, in one embodiment, timing generator 92 provides clock output 40 and additional clock outputs generally designated by reference numeral 94.

In one embodiment, the dual-channel sigma-delta ADC 54 and the dual-channel sigma-delta DAC 80 each perform respective conversions at a substantially equal or same clock rate. In one embodiment, the sample rate (or clock rate) is on the order of approximately 187.5 kHz. Furthermore, in another embodiment, BTSC encoder 12 includes a single-chip BTSC encoder and wherein the analog summing device 82 is disposed external to the single-chip BTSC encoder, as shown in FIG. 2.

Accordingly, the embodiments of the present disclosure provide a more cost-effective solution by the fully integrated digital systems as presented herein. All signal processing is digitally performed by the audio processor 48, while on-chip converters and a sync separator interface the chip 12 with the external analog world. Since oversampling converters are used, anti-aliasing and smoothing filters (16 and 18, respectively, FIG. 1) are very simple. That is, only a few external passive components are necessary.

In one embodiment, an original frequency plan using a sampling frequency of 187.5 kHz was devised to reduce the complexity of the clock generation. Accordingly, all clocks can be derived directly from the crystal oscillator, thus avoiding the use of a phase-locked-loop (PLL). In particular, the clock generator, in addition to generating the clocks for all the blocks of the encoder, also generates a clock for use by an RF modulator. By supplying the clock directly to the RF modulator, some system simplification is achieved, in view of the fact that an additional crystal would no longer be needed.

In traditional digital encoders, the modulated L−R channel is much noisier than the L+R channel. When adding the two channels together, the L−R channel out-of-band noise is added to the L+R channel as well, thus affecting the overall system performance. This issue has been solved with the embodiments of the present disclosure by using a digital anti-splatter filter as disclosed herein. The digital anti-splatter filter has very tight amplitude and phase distortion requirements.

In existing digital encoders input audio signals are digitized at a baseband sampling frequency Fₛ. Part of the signal processing is performed at Fₛ and part at 4Fₛ (i.e., four times the sampling frequency Fₛ). Interpolators are required to upsample the signals. According to one embodiment of the present disclosure, a higher rate of 187.5 kHz is used to sample the incoming audio signals and to perform all BTSC signal processing. In this way, a simplified decimator is needed in the ADCs and no interpolator is required.

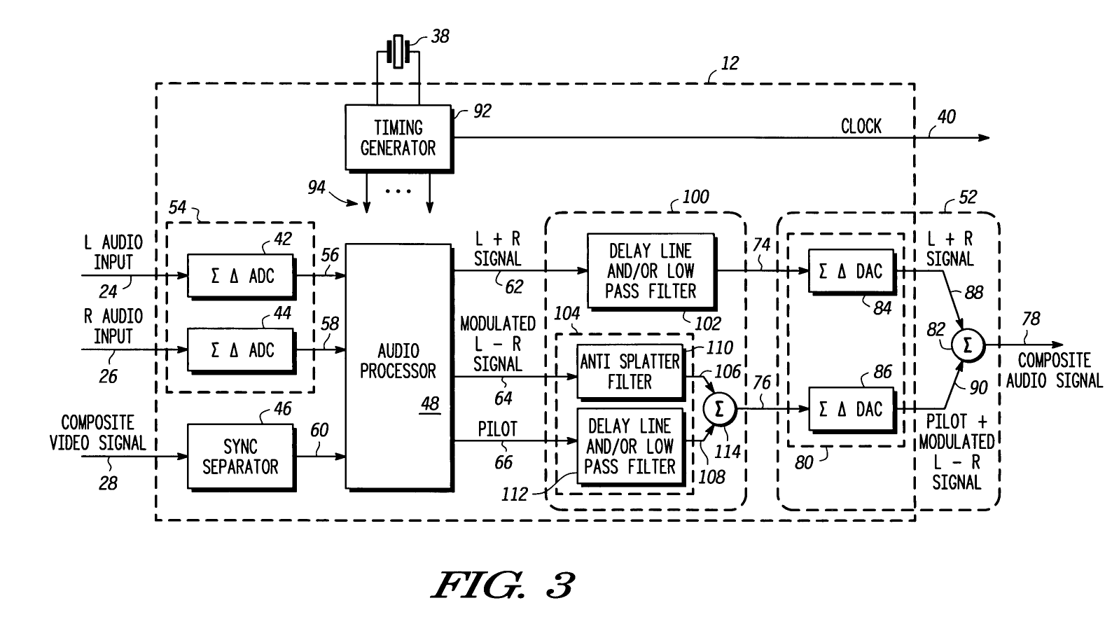

Referring now to FIG. 3, a schematic block diagram view of a BTSC encoder of FIG. 1 is shown in further detail according to another embodiment of the present disclosure. The BTSC encoder of FIG. 3 is similar to that of FIG. 2 with the following differences. Filtering means 100 couples to the L+R output, the modulated L−R output, and the pilot tone output of the audio processor 48. The filtering means 100 includes a first filter 102 for providing a filtered or delayed L+R signal, and a second filter 104 for providing a separately filtered modulated L−R signal and separately filtered or delayed pilot on outputs 106 and 108, respectively. A digital summing device 114 combines the outputs on 106 and 108 to provide output 76 of filtering means 100.

As mentioned, second filter 104 of filtering means 100 provides separately filtered modulated L−R and pilot signals on a second and a third output 106 and 108, respectively. The second filter 104 includes an anti-splatter filter 110 for filtering the modulated L−R signal and having an output for providing the filtered modulated L−R signal output corresponding to the first output 106 of the second filter 104. Second filter 104 further includes another filter 112 for filtering or delaying the pilot signal and having an output for providing the filtered pilot signal corresponding to the third output 108 of the second filter 104. Furthermore, the filtering means 100 outputs the filtered L+R signal on a first output 74, and outputs the combined separately filtered modulated L−R and pilot signals on output 76 via digital summing device 114.

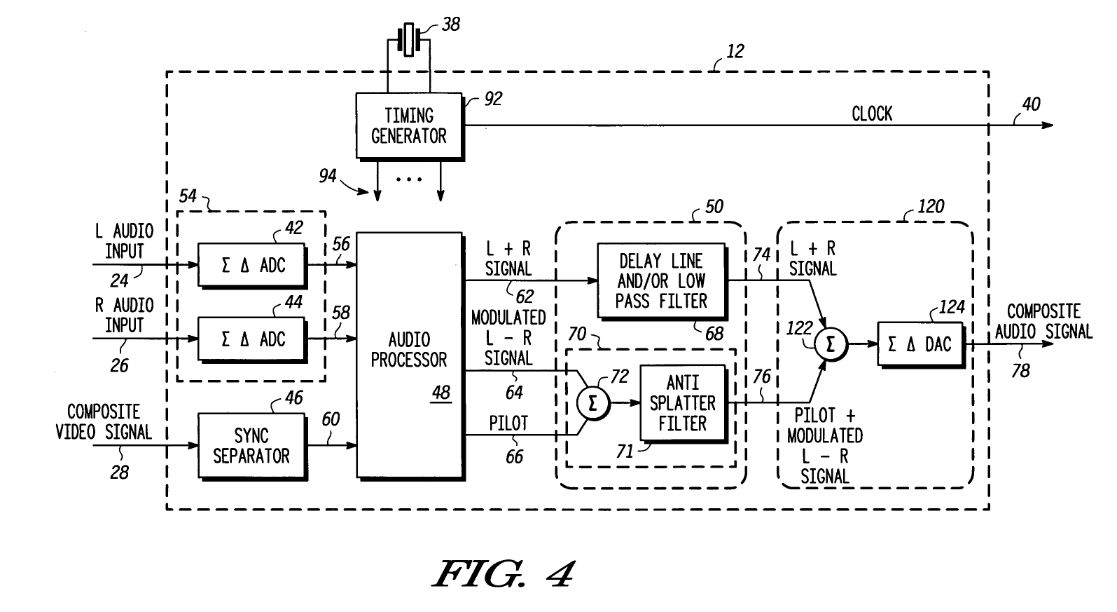

Referring now to FIG. 4, a schematic block diagram view of a BTSC encoder of FIG. 1 is shown in further detail according to another embodiment of the present disclosure. The BTSC encoder of FIG. 4 is similar to that of FIG. 2 with the following differences.

Composite audio signal generating means 120 couples to the first and second outputs 74 and 76, respectively, of filtering means 50. Composite audio signal generating means 120 includes a digital summing device 122 and a single channel sigma-delta digital-to-analog converter (DAC) 124. Responsive to the filtered L+R signal and the filtered and combined pilot and modulated L−R signal, the composite audio signal generating means 120 sums the input signals via summing device 122 and converts the summed signal into an analog representation via DAC 124, to generate a composite analog audio signal on composite analog audio signal output 78.

In one embodiment, BTSC encoder 12 includes a single-chip BTSC encoder, and wherein the digital summing device 122 is disposed within the single-chip BTSC encoder. Furthermore, in another embodiment, sigma-delta ADC 54 and the single channel sigma-delta DAC 124 each perform respective conversions at a substantially equal or same clock rate. In one embodiment, the sample rate is on the order of approximately 187.5 kHz.

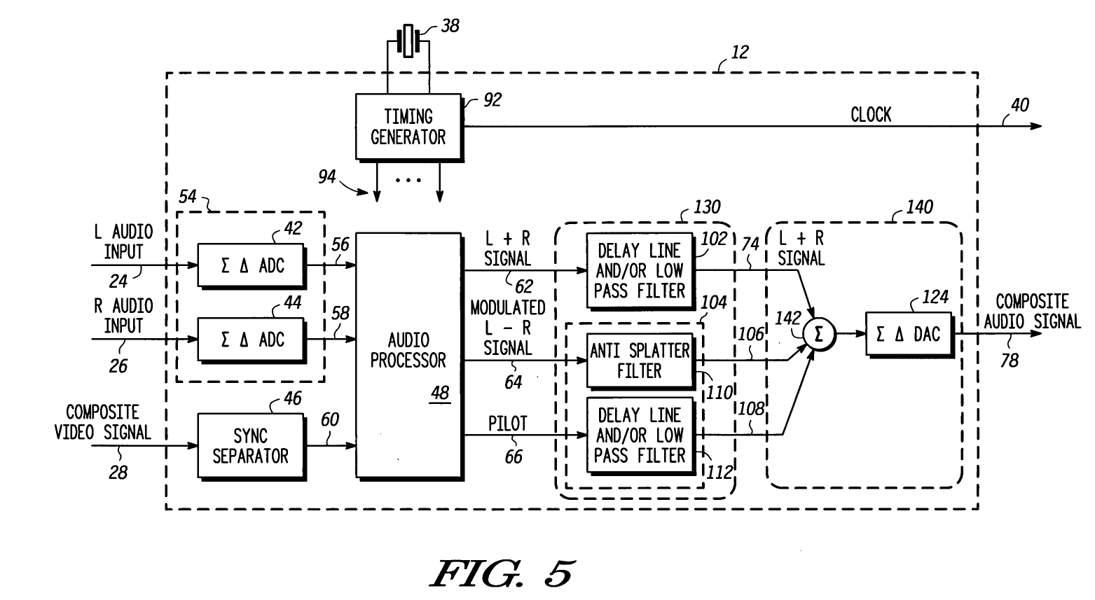

Referring now to FIG. 5, a schematic block diagram view of a BTSC encoder of FIG. 1 is shown in further detail according to another embodiment of the present disclosure. The BTSC encoder of FIG. 5 is similar to that of FIG. 4 with the following differences.

Filtering means 130 couples to the L+R output, the modulated L−R output, and the pilot tone output of the audio processor 48. The filtering means 130 includes a first filter 102 for providing a filtered L+R signal, and a second filter 104 for providing a separately filtered modulated L−R signal and separately filtered pilot on outputs 106 and 108, respectively. The second filter 104 includes an anti-splatter filter 110 for filtering the modulated L−R signal and outputting the filtered modulated L−R signal on the first output 106 of the second filter 104. Second filter 104 further includes another filter 112 for filtering the pilot signal and outputting the filtered pilot signal on the third output 108 of the second filter 104.

Composite audio signal generating means 140 couples to the outputs 74, 106 and 108 of filtering means 130. Composite audio signal generating means 140 includes a digital summing device 142 and a single channel sigma-delta digital-to-analog converter (DAC) 124. Responsive to the filtered L+R, modulated L−R signal, and pilot signals, the composite audio signal generating means 140 sums the input signals via summing device 142 and converts the resultant summed signal into an analog representation via DAC 124, to generate a composite analog audio signal on composite analog audio signal output 78.

The digital summing device 142 includes a L+R digital audio input coupled to the L+R output of the audio processor 48, a modulated L−R digital audio input coupled to the modulated L−R output of the audio processor 48, and a pilot input coupled to the pilot output of the audio processor 48, via filtering means 130. Responsive to the filtered L+R digital audio, the modulated L−R digital audio, and the pilot tone signals, the digital summing device 142 digitally sums the respective input signals into a composite L+R and combined pilot and modulated L−R digital audio signal. The digital summing device outputs the composite L+R and combined pilot and modulated L−R digital audio signal on a digital summing device output to the sigma-delta DAC 124.

Sigma-delta DAC 124 includes an input coupled to the summing device output and is adapted for receiving the composite L+R and combined pilot and modulated L−R digital audio signal. Responsive to the composite L+R and combined pilot and modulated L−R digital audio signal, the sigma-delta DAC 124 converts the input signal into a composite L+R and combined pilot and modulated L−R analog audio signal. Sigma-delta DAC 124 outputs the composite L+R and combined pilot and modulated L−R analog audio signal on a sigma-delta DAC output, corresponding to output 78 of BTSC encoder 12.

Advantages of the embodiments of the present disclosure include one or more of a cost reduction on the order of fifty percent (50%) or more (compared to solutions based on discrete parts), better performance, and a simplified system design. For example, advantages of the embodiments of the present disclosure further include enabling a lower system component count, use of a smaller system board size, and significantly lower overall system cost. Furthermore, the embodiments eliminate manual alignment of filters, phase controls, and composite signal amplitude controls. Still further, one embodiment includes an integrated circuit having mixed-signal blocks (Sigma-Delta ADCs and DACs, Sync Separator), an audio processor for BTSC encoding, and an anti-splatter filter.

According to one embodiment of the present disclosure, a Multi-Channel Television Sound (MTS) stereo encoder includes a single-chip, CMOS implementation of a Broadcast Television Systems Committee (BTSC)—compatible stereo encoder. The MTS stereo encoder can be used in set-top boxes, VCRs, DVD players/recorders, game stations, and other applications that can benefit from high-quality stereo sound through a single RF coaxial cable. The digital audio processing of the single-chip MTS stereo encoder preserves the full fidelity of surround sound and other audio coding schemes. In addition, the MTS stereo encoder processes right and left analog audio signals and baseband composite video to generate a stereophonic composite signal in accordance with BTSC system standards. Moreover, in another embodiment, the MTS stereo encoder outputs the stereophonic composite signal to an RF modulator, which in turn produces a stereo encoded RF channel for use with any BTSC stereo television receiver.

The MTS stereo encoder includes various modules. In a phased lock loop (APLL) module, the APLL module locks to a reference frequency of 12 MHz and generates a master clock. The APLL module includes an oscillator, a voltage controlled oscillator (VCO), and a clock generator. The oscillator has a crystal input and a crystal output for being coupled across a crystal oscillator, for example, a 12 MHz crystal. The oscillator provides a reference clock to an input of the VCO. Responsive to the reference clock input, the VCO outputs a phase-locked-loop output signal to an input of the clock generator. Responsive to the input signal, the clock generator, in addition to generating the clocks for all the blocks of the encoder, also generates a clock for the RF modulator, for example, 4 MHz.

In a sync separator module, the sync separator module extracts a composite sync from an incoming composite video baseband signal (CVBS). The composite sync is used by an audio processor module portion of the MTS stereo encoder to generate a 15.734 kHz pilot tone and a 31.468 kHz carrier to modulate the L−R channel. In one embodiment, the nominal output level of composite video signal sources is on the order of 1 Vₚₚ on 75 Ω and the sync amplitude is on the order of 0.2857 V.

According to the embodiments of the present disclosure, a fully integrated digital system provides a more cost-effective solution. In the single-chip BTSC encoder, all signal processing is digitally performed by the audio processor, while on-chip stereo Sigma-Delta ADC, stereo Sigma-Delta DAC, as well as, a sync separator interface the chip with the external analog world. Since oversampling converters are employed, anti-aliasing and smoothing filters are kept simple. In addition, external passive components are kept to a minimum.

In one embodiment, the single-chip BTSC encoder has two outputs, a L+R channel (stereophonic sum) and modulated L−R channel (stereophonic difference), which must be scaled and added together in the analog domain to generate the composite audio. BTSC encoding algorithms are implemented in the audio processor.

In another embodiment, the single-chip BTSC encoder has two outputs, a L+R channel (stereophonic sum) and modulated L−R channel (stereophonic difference), which must be scaled and added together in the digital domain to generate the composite audio. This provides at least two advantages: 1) only a single Sigma-Delta DAC is needed; 2) the amplitude ratio of the two channels is more accurately implemented as specified by the BTSC standard with digital scaling and therefore the amplitude ratio does not depend on the tolerance of analog components.

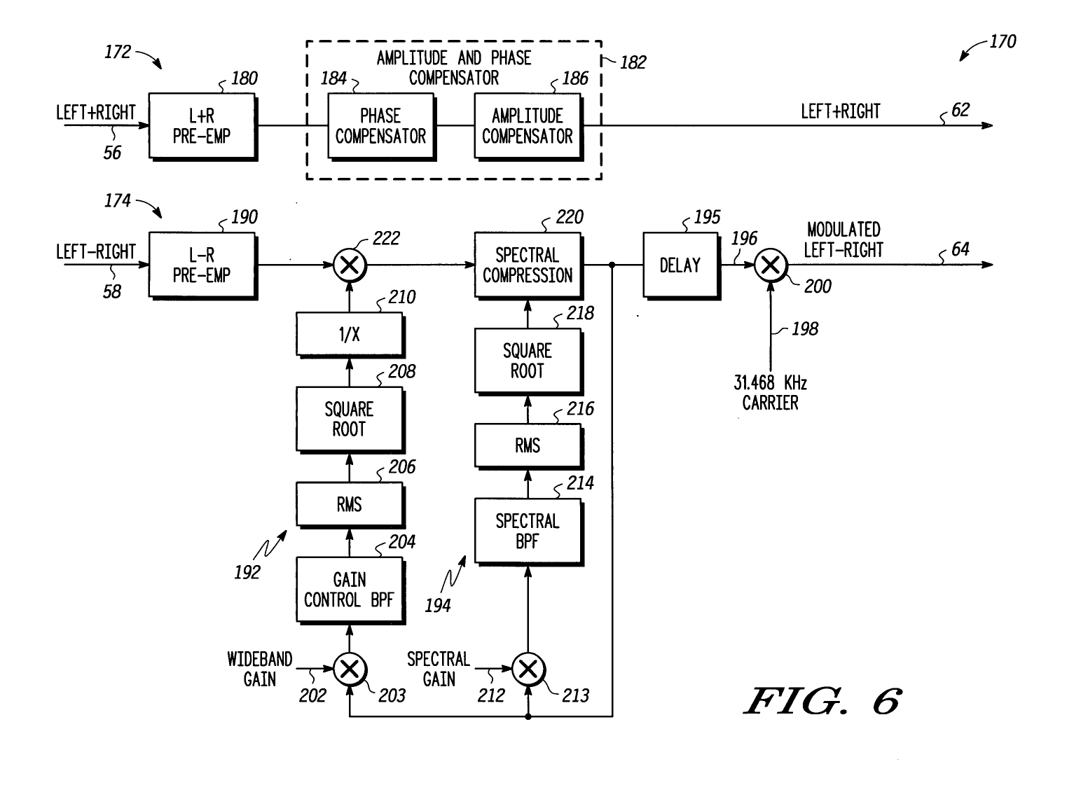

FIG. 6 is a schematic block diagram view of a portion 170 of the audio processor 48 of the BTSC encoder 12 of FIG. 1 in further detail according to another embodiment of the present disclosure. The portion 170 of the audio processor 48 includes a sum channel (Left+Right) 172 and a difference channel (Left−Right) 174. The sum channel 172 includes a Left+Right pre-emphasis filter 180 and a combined amplitude and phase compensator 182. The L+R pre-emphasis filter 180 includes a typical 75 microseconds pre-emphasis filter that performs at least the function as required by the BTSC analog counterpart, as is known in the art.

The combined amplitude and phase compensator 182 provides compensation for amplitude and phase differences between the sum and difference channels. Amplitude and phase differences and/or deviations are usually due to the limitations of translating complex analog filter responses accurately into the digital domain. In one embodiment, combined amplitude and phase compensator 182 comprises a separate phase compensator 184 and an amplitude compensator 186. The phase compensator 184 compensates for phase differences and/or deviations in the L+R channel introduced via the mappings and approximations. Similarly, the amplitude compensator 186 compensates for amplitude differences and/or deviations in the L+R channel introduced via the mappings and approximations. In addition, sum channel 172 outputs a compensated Left+Right signal on output 62.

Note that while the combined amplitude and phase compensator 182 has been described as including a phase compensator and an amplitude compensator, the combined amplitude and phase compensator 182 can be configured to compensate for phase errors and/or amplitude errors. That is, some system applications may require either compensator alone or both compensators, according to the requirements of a particular system application.

In one embodiment, phase compensator 184 comprises an all-pass filter, such as an FIR or IIR filter. The all-pass filter is configured to compensate for the phase differences and/or deviations as discussed herein above. In addition, amplitude compensator 186 can comprise an FIR or IIR filter. The amplitude compensator 186 is configured to compensate for the amplitude differences and/or deviations as discussed herein above. In addition, the particular compensation provided by the phase compensator 184 and amplitude compensator 186 depends, in part, on at least the mappings used in a particular BTSC encoder implementation and the devices of an actual implementation. The mappings convert the analog design to a digital design.

Referring still to FIG. 6, difference channel (Left−Right) 174 includes a Left−Right pre-emphasis filter 190, wideband gain loop 192, spectral compression loop 194, and delay 195. The L−R difference signal at input 58 is processed by the pre-emphasis filter, wideband gain loop, spectral compression loop, and delay and provided as a processed L−R difference signal on output 196. The output 196 is modulated by a carrier 198 at multiplier 200, furthermore for providing a modulated Left−Right output 64. In one embodiment, the carrier 198 includes a 31.468 kHz carrier (i.e., exactly twice the horizontal line rate of the NTSC system).

The Left−Right pre-emphasis filter 190 is a stereophonic difference channel pre-emphasis filter that performs at least the function as required by the BTSC analog counterpart, as is known in the art. Wideband gain loop 192 includes a fixed wideband gain (i.e. scaling) input 202, multiplier 203, gain control band pass filter (BPF) 204, exponentially time weighted root-mean-square integration function blocks 206 (RMS portion) and 208 (square root portion), inversion block 210, and multiplier 222. Wideband gain loop 192 performs according to the BTSC standards.

Spectral compression loop 194 includes a fixed spectral gain (i.e. scaling) input 212, multiplier 213, spectral band pass filter (BPF) 214, exponentially time weighted root-mean-square integration function blocks 216 (RMS portion) and 218 (square root portion), and programmable spectral compression filter 220. Spectral compression loop 194 performs according to the BTSC standards. An output of the programmable spectral compression filter is looped back to the wideband gain loop 192 at multiplier 203 as well as to the spectral compression loop 194 at multiplier 213, to ensure that the difference channel signal is correctly coded.

In addition, delay 195 comprises any suitable delay block for introducing a delay in the difference channel 174, wherein the delay is configured to substantially match a delay introduced by the amplitude and phase compensator 182 in the sum channel 172. For example, delay 195 can include any multiple of a unit delay, such as provided by one or more of a register, flip-flop, or other suitable digital device.

Tables 1 and 2 list amplitude and phase errors, respectively, for separations ranging from −14 dB (i.e., low separation) to −40 dB (i.e., high separation). For example, to achieve a separation of −40 dB, assuming that there is no amplitude error, the maximum phase error allowed is 1.1 degrees, or vice versa, assuming that there is no phase error, the maximum amplitude error is 0.18 dB. However, if, due to filter mismatches, the amplitude and/or phase errors exceed these limits, then the separation of −40 dB can no longer be reached. For example, if with no amplitude error the phase error increases to 2.3 degrees, or with no phase error the amplitude error increases to 0.35 dB, then the separation degrades to −34 dB. The phase and amplitude compensation as discussed herein provide for realizing the values of Tables 1 and 2. Accordingly, the encoder performance is greatly enhanced.

TABLE 1
BTSC Separation Versus Amplitude Error

| | |
|---|---|
| Amplitude Error | Attainable Separation |

| | | |
|---|---|---|
| 3.5 | dB | −14 dB |
| 1 | dB | −24 dB |
| .35 | dB | −34 dB |
| .18 | dB | −40 dB |

TABLE 2
BTSC Separation Versus Phase Error

| Phase Error | Attainable Separation |
|---|---|
| 22.5 deg | −14 dB |
| 7.2 deg | −24 dB |
| 2.3 deg | −34 dB |
| 1.1 deg | −40 dB |

The embodiments of the present disclosure provide for a more cost-effective way in compensating for amplitude and/or phase errors through the use of amplitude and/or phase compensators in the left+right channel, in the left−right channel, or in both channels. As discussed herein, the compensators can be implemented with FIR or IIR filters.

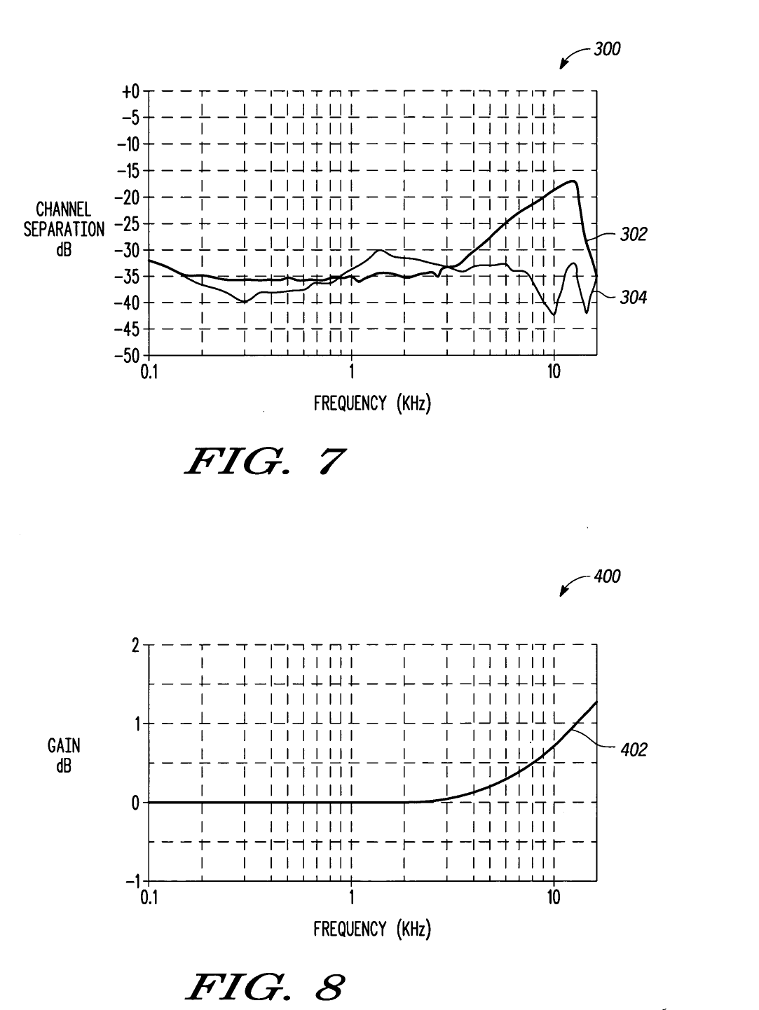

FIG. 7 is a graphical representation view 300 of a frequency response of channel separation in dB versus frequency of (i) a BTSC encoder without amplitude and phase compensators, indicated by reference numeral 302, and (ii) a BTSC encoder with amplitude and phase compensators according to one embodiment of the present disclosure, indicated by reference numeral 304. In this example, the amplitude and phase mismatches between the sum and difference channels in the known BTSC encoder adversely affect the performance of the BTSC encoder. As shown, the degradation occurs in such a way that the channel separation degrades appreciably at frequencies higher than about 4 kHz.

With respect to the BTSC encoder with amplitude and phase compensators according to one embodiment of the present disclosure, the amplitude and phase mismatches between the sum and difference channels in the novel BTSC encoder are compensated for by the amplitude and phase compensators. As shown, the curve indicated by reference numeral 304 indicates that the channel separation of the BTSC encoder with amplitude and phase compensators remains at a level better than −30 dB separation over the frequency range of operation, i.e., from 0.1 to 15 kHz.

FIG. 8 is a graphical representation view 400 of an amplitude response of the amplitude compensator of the BTSC encoder according to one embodiment of the present disclosure. In particular, the curve indicated by reference numeral 402 demonstrates that the amplitude response has a minimum effect on the gain over the frequency range of 0.1 kHz to approximately 2 kHz. After 2 kHz, the amplitude response compensates for the amplitude differences and/or deviations between the sum and difference channels that occur due to errors in mapping from the analog domain to the digital domain, in addition, to errors in approximations used for the digital implementation. More particularly, the amplitude compensator compensates for amplitude differences up to a maximum gain on the order of approximately 1.2 to 1.3 dB at 15 kHz.

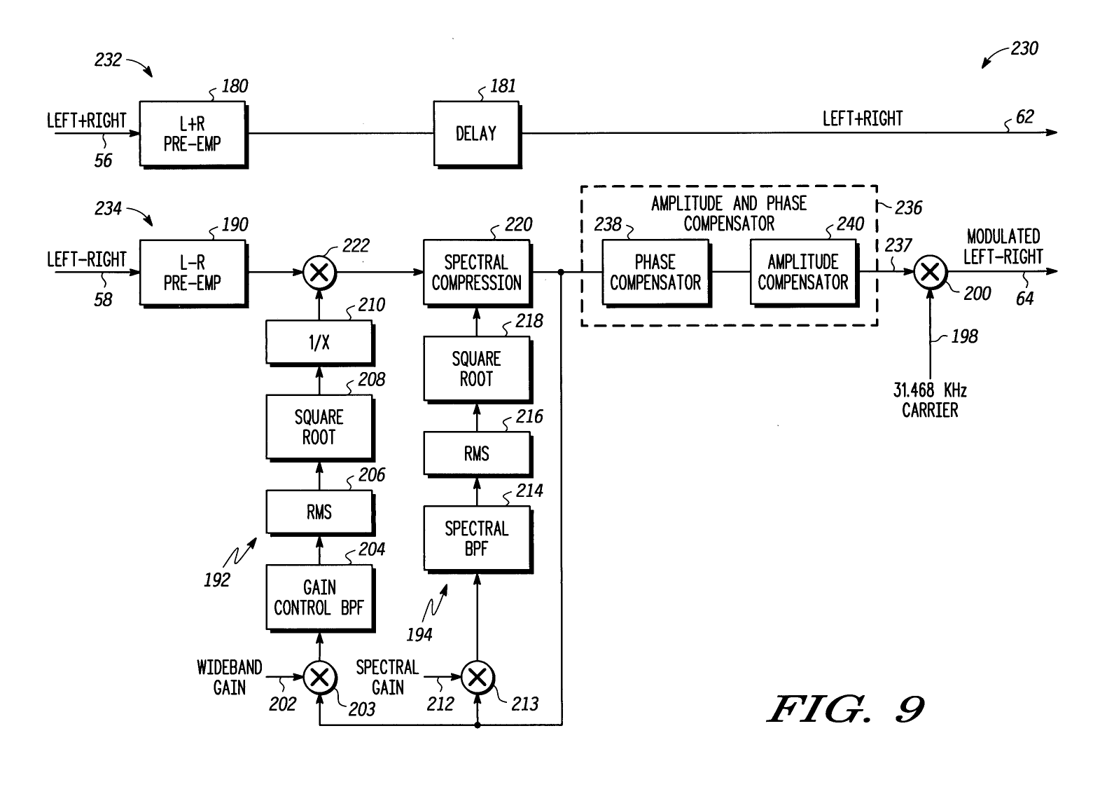

FIG. 9 is a schematic block diagram view of a portion 230 of the audio processor 48 of the BTSC encoder 12 of FIG. 1 in further detail according to yet another embodiment of the present disclosure. The portion 230 is similar to portion 170 as discussed with respect to FIG. 6 with the following differences. The portion 230 of the audio processor 12 includes a sum channel (Left+Right) 232 and a difference channel (Left−Right) 234.

The sum channel 232 includes a Left+Right pre-emphasis filter 180 and a delay 181. Delay 181 comprises any suitable delay block for introducing a delay in the sum channel 232. In particular, delay 181 is configured to substantially match a delay introduced by an amplitude and phase compensator 236 in the difference channel 234, as further discussed herein. For example, delay 181 can include any multiple of a unit delay, such as provided by one or more of a register, flip-flop, or other suitable digital device.

Referring still to FIG. 9, difference channel (Left−Right) 234 includes a Left−Right pre-emphasis filter 190, wideband gain loop 192, spectral compression loop 194, and a combined amplitude and phase compensator 236. The L−R difference signal at input 58 is processed by the pre-emphasis filter, wideband gain loop, spectral compression loop, and the combined amplitude and phase compensator and is provided as a processed L−R difference signal on output 237. The output 237 is modulated by a carrier 198 at multiplier 200, furthermore for providing a modulated Left−Right output 64. In one embodiment, the carrier 198 includes a 31.468 kHz carrier (i.e., exactly twice the horizontal line rate of the NTSC system).

The combined amplitude and phase compensator 236 provides compensation for amplitude and phase differences between the difference and sum channels. As previously mentioned, amplitude and phase differences and/or deviations can occur due to errors in mapping from the analog domain to the digital domain, in addition, to errors in approximations used for the digital implementation. In one embodiment, combined amplitude and phase compensator 236 is similar to amplitude and phase compensator 182 and comprises a separate phase compensator 238 and an amplitude compensator 240. The phase compensator 238 compensates for phase differences and/or deviations in the L−R channel introduced via the mappings and approximations. Similarly, the amplitude compensator 240 compensates for amplitude differences and/or deviations in the L−R channel introduced via the mappings and approximations.

In one embodiment, phase compensator 238 comprises an all-pass filter, such as an FIR or IIR filter. The all-pass filter is configured to compensate for the phase differences and/or deviations as discussed herein above. In addition, amplitude compensator 240 can comprise an FIR or IIR filter. The amplitude compensator 240 is configured to compensate for the amplitude differences and/or deviations as discussed herein above. In addition, the particular compensation provided by the phase compensator 238 and amplitude compensator 240 depends, in part, on at least the mappings used in a particular BTSC encoder implementation and the devices of an actual implementation. The mappings convert the analog design to a digital design. Furthermore, delay 181 in the sum channel 232 is configured to substantially match a delay introduced by the amplitude and phase compensator 236 in the difference channel 234.

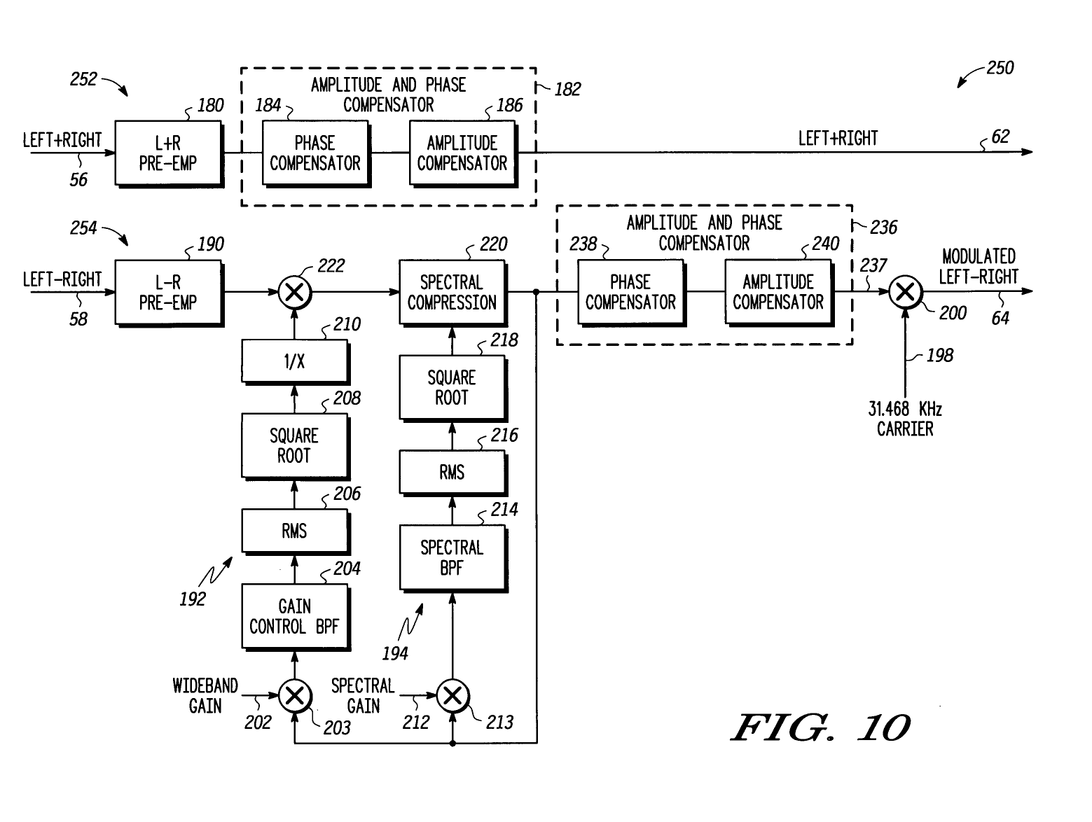

FIG. 10 is a schematic block diagram view of a portion 250 of the audio processor 48 of the BTSC encoder of FIG. 1 in further detail according to yet still another embodiment of the present disclosure. The portion 250 is similar to portions 170 and 230 as discussed with respect to FIGS. 6 and 9, respectively, with the following differences. The portion 250 of the audio processor 48 includes a sum channel (Left+Right) 252 and a difference channel (Left−Right) 254. The sum channel 252 includes a Left+Right pre-emphasis filter 180 and a combined amplitude and phase compensator 182, similar to sum channel (Left+Right) 172 discussed herein with respect to FIG. 6. Difference channel (Left−Right) 254 includes a Left−Right pre-emphasis filter 190, wideband gain loop 192, spectral compression loop 194, and a combined amplitude and phase compensator 236, similar to difference channel (Left−Right) 234 discussed herein with respect to FIG. 9. The delay introduced by the combined amplitude and phase compensator 182 is configured to be on the order of the delay introduced by the combined amplitude and phase compensator 236, or vice versa.

As discussed herein, with respect to traditional digital BTSC encoders, the modulated L−R channel is much noisier than the L+R channel. When combining the two channels together, the L−R channel out-of-band noise is added to the L+R channel as well, thus affecting an overall system performance. With the embodiments of the present disclosure, this problem has been solved by inserting a digital anti-splatter filter on the modulated L−R output to reduce the out-of-band noise. The filter characteristic can include a highpass filter or a bandpass filter. The filter also has very tight requirements as regards to phase distortion.

With the embodiments of the present disclosure, equipment can be constructed to include built-in BTSC encoders as disclosed herein. Accordingly, various audio/video applications with the built-in BTSC encoders can be serially connected (or daisy chained) via coaxial cables to a set-top box and all receive stereo audio. Moreover, the wiring is simplified.

In the foregoing specification, the invention has been described with reference to specific embodiments. However, one of ordinary skill in the art appreciates that various modifications and changes can be made without departing from the scope of the present invention as set forth in the claims below. For example, the sigma-delta DAC may be external to the BTSC encoder. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A BTSC (Broadcast Television Systems Committee) encoder, comprising:
a first analog-to-digital converter (ADC) for receiving a left (L) audio input, and in response, providing a digital L audio signal;
a second ADC for receiving a right (R) audio input, and in response, providing a digital R audio signal;
a sum channel (L+R) having a L audio input for receiving the digital L audio signal, a right (R) audio input for receiving the digital R audio signal, and an output for providing a digital L+R signal;
a difference channel (L−R) having a L audio input for receiving the digital L audio signal, a right (R) audio input for receiving the digital R audio signal, and an output for providing a digital L−R signal; and
one or more of
(i) a phase compensator, coupled to the sum channel, for compensating for a phase difference between the digital L+R signal and the digital L−R signal and
(ii) an amplitude compensator, coupled to the sum channel, for compensating for an amplitude difference between the digital L+R signal and the digital L−R signal.

2. The BTSC encoder of claim 1, wherein the first and second ADCs are characterized as being sigma-delta ADCs.

3. The BTSC encoder of claim 1, wherein the difference channel further comprises a delay line for matching a propagation delay in the phase compensator, the amplitude compensator, or both the phase compensator and the amplitude compensator.

4. The BTSC encoder of claim 1, wherein the difference channel further comprises:
one or more of
(iii) a second phase compensator for compensating for a phase difference between the digital L+R signal and the digital L−R signal and
(iv) a second amplitude compensator for compensating for an amplitude difference between the digital L+R signal and the digital L−R signal.

5. The BTSC encoder of claim 1, wherein the sum channel comprises:
a pre-emphasis filter having an input for receiving the digital L+R signal, and an output for providing a filtered L+R signal;
the phase compensator having an input coupled to receive the filtered L+R signal, and an output for providing a compensated L+R signal; and
the amplitude compensator having an input coupled to the output of the phase compensator, and an output.

6. The BTSC encoder of claim 1, further comprising a summation element having a first input for receiving the digital L+R signal, a second input for receiving the digital L−R signal, and an output for providing a composite audio signal.

7. The BTSC encoder of claim 6, wherein the summation element is implemented in the analog or digital domain.

8. The BTSC encoder of claim 1, wherein the BTSC encoder is implemented on an integrated circuit.

9. The BTSC encoder of claim 1, wherein the phase compensator and the amplitude compensator are each implemented as at least one selected from the group consisting of finite impulse response (FIR) filters and infinite impulse response (IIR) filters.

10. The BTSC encoder of claim 1, wherein the phase compensator and the amplitude compensator are implemented together in at least one selected from the group consisting of a finite impulse response (FIR) filter and an infinite impulse response (IIR) filter.

11. A BTSC (Broadcast Television Systems Committee) encoder, comprising:
a first analog-to-digital converter (ADC) for receiving a left (L) audio input, and in response, providing a digital L audio signal;
a second ADC for receiving a right (R) audio input, and in response, providing a digital R audio signal;
a sum channel (L+R) having a L audio input for receiving the digital L audio signal, a right (R) audio input for receiving the digital R audio signal, and an output for providing a digital L+R signal;
a difference channel (L−R) having a L audio input for receiving the digital L audio signal, a right (R) audio input for receiving the digital R audio signal, and an output for providing a digital L−R signal; and
one or more of
(i) a phase compensator, coupled to the difference channel, for compensating for a phase difference between the digital L+R signal and the digital L−R signal and
(ii) an amplitude compensator, coupled to the difference channel, for compensating for an amplitude difference between the digital L+R signal and the digital L−R signal.

12. The BTSC encoder of claim 11, wherein the sum channel further comprises a delay line for matching a propagation delay in the phase compensator and the amplitude compensator.

13. The BTSC encoder of claim 11, wherein the sum channel further comprises:
one or more of
(iii) a second phase compensator for compensating for a phase difference between the digital L+R signal and the digital L−R signal and
(iv) a second amplitude compensator for compensating for an amplitude difference between the digital L+R signal and the digital L−R signal.

14. The BTSC encoder of claim 11, wherein the difference channel comprises:
a pre-emphasis filter having an input for receiving the digital L−R signal, and an output;
a gain control loop, coupled to the output of the pre-emphasis filter, for providing gain control to the difference channel;
a spectral compression loop coupled to the output of the pre-emphasis filter;
the phase compensator having an input coupled to the output of the pre-emphasis filter, and an output; and
the amplitude compensator having an input coupled to the output of the phase compensator, and an output.

15. The BTSC encoder of claim 11, further comprising a summation element having a first input for receiving the digital L+R signal, a second input for receiving the digital L−R signal, and an output for providing a composite audio signal.

16. The BTSC encoder of claim 15, wherein the summation element is implemented in the analog or digital domain.

17. The BTSC encoder of claim 11, wherein the BTSC encoder is implemented on an integrated circuit.

18. The BTSC encoder of claim 1 1, wherein the phase compensator and the amplitude compensator are each implemented as at least one selected from the group consisting of finite impulse response (FIR) filters and infinite impulse response (IIR) filters.

19. The BTSC encoder of claim 11, wherein the phase compensator and the amplitude compensator are implemented together in at least one selected from the group consisting of a finite impulse response (FIR) filter and an infinite impulse response (IIR) filter.

20. A method for encoding a BTSC (Broadcast Television Systems Committee) comprising:
converting an analog left (L) audio input signal to a digital L audio signal;
converting an analog right (R) audio input signal to a digital R audio signal;
providing the digital L audio signal and the digital R audio signal to a sum channel (L+R), and in response, the sum channel providing a digital L+R signal;
providing the digital L audio signal and the digital R audio signal to a difference channel (L−R), and in response, the difference channel providing a digital L−R signal; and one or more of
(i) compensating for a phase difference between the digital L+R signal and the digital L−R signal and
(ii) compensating for an amplitude difference between the digital L+R signal and the digital L−R signal.

21. The method of claim 20, further comprising adding the L+R signal to the L−R signal to produce a composite signal.

22. The method of claim 20, wherein compensating for the phase difference comprises filtering the digital L+R signal using a finite impulse response (FIR) filter.

23. The method of claim 20, wherein compensating for the amplitude difference comprises filtering the digital L+R signal using a finite impulse response (FIR) filter.

24. The method of claim 20, wherein compensating for the phase difference comprises filtering the digital L−R signal using a finite impulse response (FIR) filter.

25. The method of claim 20, wherein compensating for the amplitude difference comprises filtering the digital L−R signal using a finite impulse response (FIR) filter.

26. The method of claim 20, wherein the method is implemented on an integrated circuit.
